(19) United States
(12) Patent Application Publication
(10) Pub. No.: US 2011/0048330 A1
(43) Pub. Date: Mar. 3, 2011

(54) Odor free kitty litter with vented enclosure

(76) Inventor: Will Weldon Mathews, Las Cruces, NM (US)

(21) Appl. No.: 12/584,268

(22) Filed: Sep. 2, 2009

(51) Int. Cl. A01K 29/00; F16L 41/02; F24F 7/06

(52) U.S. Cl. 119/165; 285/132.1; 285/133.11; 454/341

(57) ABSTRACT

An easily installed economical device to control in residence kitty litter odor can be constructed using an existing dryer vent system. When the cat enters the litter box enclosure, a sensor detects the cat's presence. The detector control circuits turn on a small fan to vent the obnoxious odor out through the dryer vent. The vent fan continues to operate for an adjustable set time period to insure all the odor is vented.

### BACKGROUND—FIELD

Nearly all the homes and apartments in the United States have clothes dryers. The number of homes, apartments, or other dwellings having a pet cat or cats is in the millions. Pet owners spend billions of dollars per year to care for their pets.

This invention is unique and novel in the fact that an existing clothes dryer vent is used to vent the kitty litter odor. In addition, a blower or ventilation fan is located away from the litter enclosure housing to insure the cat is not disturbed by the fan noise.

Alternatively, the dryer vent can be used to act as a draft flue without the blower fan.

The system is easily installed with no requirement to cut an opening for a cat litter vent.

### OPERATION

When the cat enters the cat litter box housing (10), the cat present sensor (11) detects the cat and a signal is routed through the feedback wire to the control box (12). The blower control box with timer (14) supplies electrical power to the blower exhaust fan (17) remotely located away from the cat litter box housing (10) to insure the cat is not disturbed by noise during defecation.

The blower control box with timer (14) can be adjusted from seconds to hours to insure the odor is vented outside of the dwelling.

A standard dryer vent hose is used to connect the kitty litter housing with open bottom (10) to the blower exhaust fan (17) or dryer (16) vent hose “Y” fitting, 15 to 89 degrees. A 90 degree “Tee” fitting is shown in FIG. 3.

Immediately after the cat defecation, the fecal material is near body temperature, approximately 100° F. The higher temperature causes the odor gases and surrounding air to rise. The rising gas flow is vented through the dryer odor control conduit flue (15) and out the clothes dryer vent flue (18) using the normal updraft of a flue.

The routing of the dryer vent flue (18) can be up, down, or horizontal when using the blower exhaust fan (16).

Optional spring loaded or gravity biased check valve (20) or a spring biased check valve (23) are used to insure the back flow from gas dryer operation does not enter the dwelling and expose the residents to carbon monoxide.

### DRAWINGS—FIGURES

FIG. 1 shows a vented kitty litter box with a vent fan to increase air flow and insure direction of air flow.

FIG. 2 shows a vented kitty litter box with updraft flow similar to a fireplace.

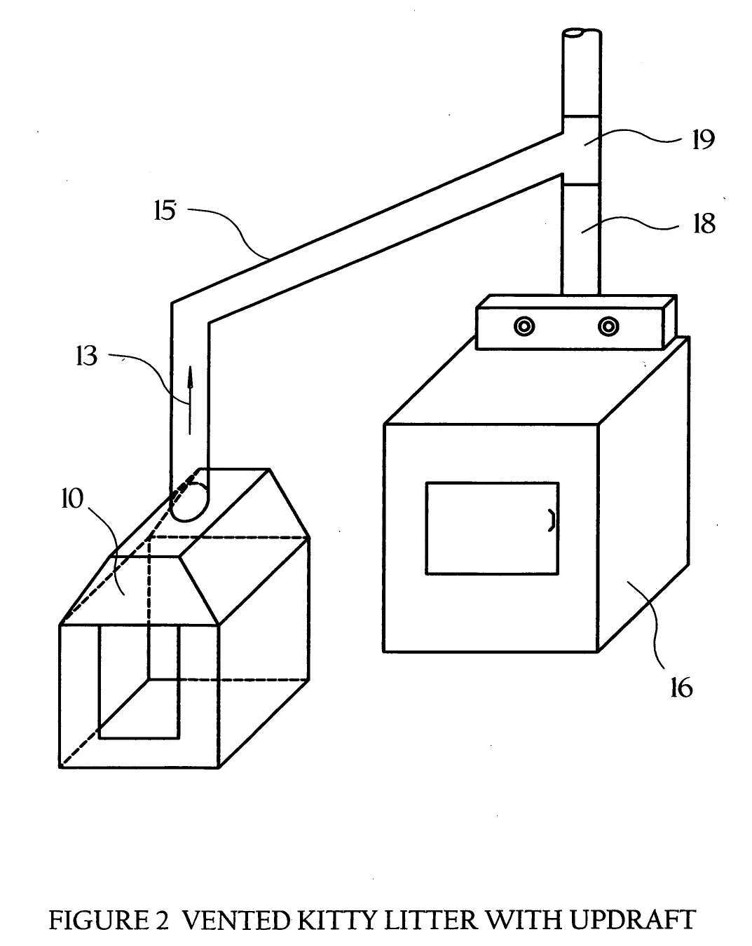

FIG. 3 Hose Tee fitting

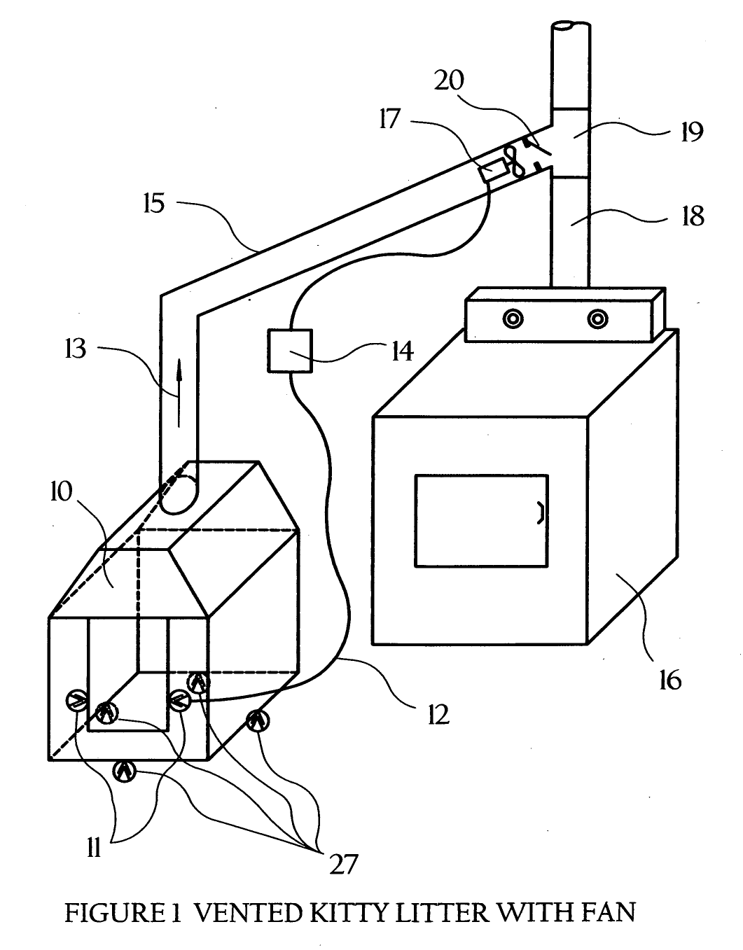

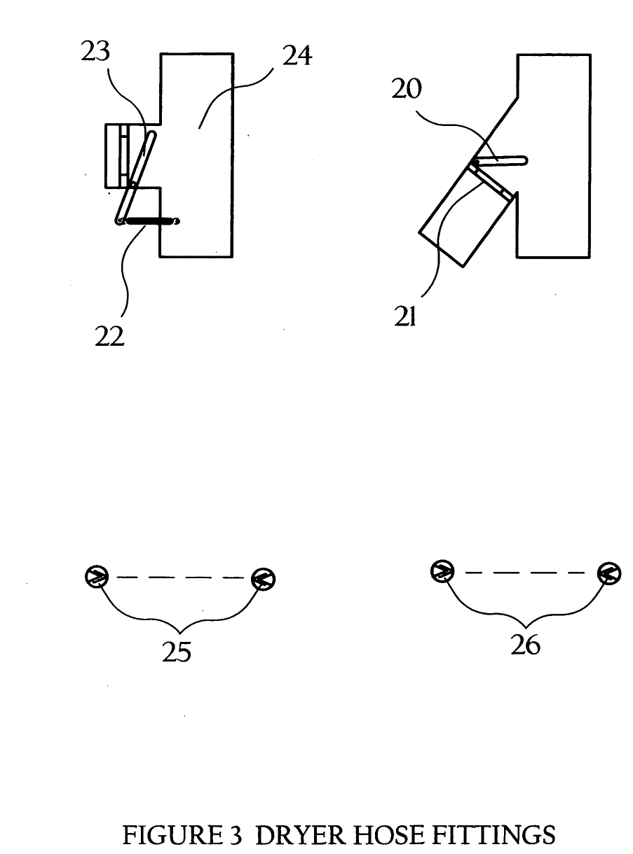

### DRAWINGS—FIGURES—REFERENCE NUMERALS FIGS. 1 & 2 NUMERAL DESCRIPTION

| NUMERAL | DESCRIPTION |
|---|---|
| 10 | Kitty litter housing with open bottom |
| 11 | Cat Present sensor |
| | (light beam, Infrared, ultrasonic, weight or load cell) |
| 12 | Feedback wire to control box |
| 13 | Flue discharge flow |
| 14 | Blower control box with timer |
| 15 | Odor conduit flue |
| 16 | Clothes Dryer |
| 17 | Blower exhaust fan |
| 18 | Clothes dryer vent flue |
| 19 | “Y” fitting 15 to 90 degrees |
| 20 | Spring loaded or gravity biased check valve |
| 21 | Weight bias vector |
| 22 | Bias extension Spring |
| 23 | Spring biased check valve |
| 24 | “Tee” fitting |
| 25 | Light beam cat present sensor and transmitter |
| 26 | Infrared beam cat present sensor and transmitter |
| 27 | Load cell cat present sensors |

I claim:

1) A “Y” fitting 15 to 90 degrees for installation in a clothes dryer vent flue (18).

2. A fitting of claim 1 wherein a “Tee”(25) is used for installation in a clothes dryer vent flue (18).

3) An inline blower exhaust fan (17) to remove odor from the kitty litter enclosure.

4) A vented kitty litter housing with open bottom (10) allowing easy access to change the kitty litter.

5) A cat present sensor (11) using ultrasonic technology.

6) A sensor of claim 5 wherein a light beam cat present sensor and transmitter (26) is utilized.

7) A sensor of claim 5 wherein an infrared beam cat present sensor and transmitter (27) is utilized.

8) A sensor of claim 5 wherein a load cell cat present sensor (28) is utilized.
